(19) United States
(12) Patent Application Publication
(10) Pub. No.: US 2004/0148162 A1
(43) Pub. Date: Jul. 29, 2004

(54) Method for encoding and transmitting voice signals

(76) Inventors: Tim Fingscheidt, Munchen (DE); Herve Taddei, Munchen (DE); Imre Varga, Munchen (DE)

Correspondence Address: BELL, BOYD & LLOYD, LLC, P. O. BOX 1135, CHICAGO, IL, 60690-1135, US

(21) Appl. No.: 10/478,142

(22) PCT Filed: May 2, 2002
(86) PCT No.: PCT/DE02/01598

(30) Foreign Application Priority Data
May 18, 2001 (DE) 1012420.7

(51) Int. Cl. G10L 19/14

(52) U.S. Cl. 704/224

(57) ABSTRACT

The invention relates to a method for encoding voice signals, especially so-called voice onset sections. By establishing the first amplification factor, the data quantity for representing the whole of the first or adaptive amplification factor and adaptive code book entry is reduced, whereby other parameters which occur during the voice encoding can be represented in a more precise manner. The invention also relates to a method for transmitting voice signals which are encoded in such a way.

The invention relates to a method for encoding voice signals, in particular with the inclusion of a number of codebooks, the entries of which are used to approximate the voice signal, and a method for transmitting voice signals.

In digital voice communication systems such as the landline network, the Internet or a digital mobile network, voice encoding methods are employed in order to reduce the bit rate to be transmitted. The voice encoding methods typically produce a bit stream of voice-encoded bits which is subdivided into frames, each of which represents, for example, 20 ms of the voice signal. The bits within a frame generally represent a specific set of parameters. A frame is often divided up in turn into subframes, so that some parameters are transmitted once per frame, others once per subframe. The US TDMA Enhanced Full Rate (EFR) voice codec operating at a bit rate of 7.4 kbps, i.e. 148 bits per 20 ms frame, may be cited as an example. A frame consists here of 4 subframes.

The meaning of the parameters occurring in so-called CELP (code-excited linear prediction) coders will be presented below by way of example with reference to this voice encoding method:

10 coefficients of what is termed an LPC (linear predictive coding) synthesis filter. They are quantized at 26 bits/frame. The filter represents the spectral envelope of the voice signal in the area of the current frame. The excitation signal for this filter is additively composed of what is termed an “adaptive excitation signal” S_a weighted with what is termed an “adaptive amplification factor” g_{—}1 and what is termed a “fixed excitation signal” S_f weighted with what is termed a “fixed amplification factor” g_{—}2.

Four subframes of the fixed excitation signal are quantized using 4×17 bits. The fixed excitation S_f consists of an entry from what is termed the “fixed codebook”, said entry being weighted with the fixed amplification factor g_{—}2. Each of the entries in the fixed codebook consists of a pulse sequence which is different from zero only at a few moments in time.

Four values of a voice base frequency are represented using 2×8 bits and 2×5 bits. The adaptive excitation signal in what are termed analysis-by-synthesis CELP encoding methods is determined from the excitation signal of the LPC synthesis filter, delayed by a period of the voice base frequency. All possible quantized voice base frequencies constitute what is termed the “adaptive codebook”, which contains the correspondingly shifted excitation signals.

Four amplification factor pairs per frame are vector quantized using 4×7 bits. The “adaptive amplification factor” is applied to the adaptive excitation signal, while the “fixed amplification factor” is applied to the fixed excitation signal. The overall excitation signal of the LPC synthesis filter is then composed, as already mentioned above, of the sum of the weighted adaptive and fixed excitation signals.

The entries in a codebook are generally referred to as code words or code vectors.

The adaptive codebook is called “adaptive” because the code vectors contained in it do not represent constants nor in fact are they present in stored form, but instead they are determined adaptively for each subframe from the past history of the overall excitation signal of the LPC synthesis filter. The fixed codebook is “fixed” to the extent that its code vectors are either available in a permanently stored form (noise excitation) or at least calculated on the basis of determined computing rules (algebraic codebook) which are not dependent on the particular subframe. The amplification factors assigned in each case usually are also referred to as “adaptive” or “fixed”. It should be noted that all four parameter types, adaptive and fixed excitation signal, as well as adaptive and fixed amplification factor, must of course be determined in each subframe, and in this sense are all “adaptive in nature”. In the following, however, the previously introduced terminology—which is also usual in the literature—will be adhered to, or alternatively the term “first amplification factor” will be used instead of “adaptive amplification factor”, and the term “second amplification factor” will be used instead of “fixed amplification factor”.

Following LPC synthesis filtering, the excitation signal S is intended to reflect as accurately as possible the voice section occurring at that moment in time, the voice signal S. The parameters g_{—}1, g_{—}2, S_a, S_f are therefore chosen such that they can be used to represent the voice signal S as closely as possible.

The excitation signal S=g_{—}1*S_a+g_{—}2*S_f thus approximates the voice signal following LPC synthesis filtering on the receiver side.

The contribution of the individual summands g_{—}1*S_a and g_{—}2* S_f to the overall excitation signal S varies as a function of the specific speech characteristics of the voice signal section.

Voice signals contain sequences of frames or subframes in which they can be modeled as stationary, in other words without development of their statistical characteristics over time. This relates here to periodic sections which can represent, for example, vowels. This periodicity is incorporated into the overall excitation signal S via the contribution g_{—}1*S_a.

There are, however, also profoundly non-stationary voice signal sections, such as what are termed “onsets” or “voice onsets”, for example. These relate to, say, plosive sounds at the beginning of a word. In this case the summand g_{—}2*S_f represents the dominant contribution to the excitation signal S′.

The statistical characteristics of a frame or subframe with an onset cannot as a rule be estimated from preceding frames or subframes. In the case of an onset it is in particular not possible to determine any long-term periodicity; in other words, the value of a voice base frequency is totally meaningless and useless. In the case of onsets, the contribution made up of adaptive amplification factor and entry from the adaptive codebook, which in fact expresses a long-term periodicity in the voice signal, is consequently more of a hindrance than a help for encoding the voice signal section. The contribution of an adaptive excitation signal to the overall excitation signal can really be detrimental in the case of onsets: If no periodicity at all is found, in other words no suitable adaptive excitation signal in the course of the adaptive codebook search, then the optimal adaptive amplification factor results in zero.

Adaptive and fixed amplification factor g_{—}1 and g_{—}2 are now frequently quantized as a number pair (g_{—}1,g_{—}2) by means of a further codebook for the amplification factors. This case of a parallel, mutually dependent quantization of the parameters is referred to as vector quantization. This codebook has of course only a limited size, typically 7 bits, by means of which it is therefore possible to realize 2⁷=128 entries with indices running from, for example, 0 to 127.

Only those indices are transmitted to the receiver which, following scalar quantization of g_{—}1 and g_{—}2 separately, result in a data compression compared with conventional transmission. Scalar quantization is understood to mean an individual, mutually independent quantization of the parameters. As already stated above, the number of entries in this codebook is limited.

Those number pairs (g_{—}1, g_{—}2) by means of which in their entirety, i.e. number pairs with index 0-127, all possible combinations of g_{—}1 and g_{—}2 occurring can best be represented are therefore used as the entry in this codebook. These are then available in the conventional way for what is termed a vector quantization. With an adaptive amplification factor g_{—}1=0, any values of the fixed amplification factor g_{—}2 can occur in principle, since with non-periodic voice sections, as already explained, the adaptive component g_{—}1*S_a specifically is considerably smaller than the fixed component, so the excitation signal S_for the LPC synthesis filter is determined by the latter and the fixed component in this case cannot be calculated from past values.

In order therefore to be able to perform an optimal adaptation of the excitation signal S′ following LPC synthesis filtering via an adjustment of the parameters g_{—}1, g_{—}2, S_{—}1, S_{—}2 to the original voice signal S also in this case g_{—}1=0, very many value pairs (g_{—}1=0, g_{—}2) would have to be added to the codebook, which is of course not possible for reasons of memory space.

To that extent, with an adjustment of the parameters in the case g_{—}1=0, a not very suitable value for g_{—}2 is usually obtained.

This leads to undesirable signal components in the overall excitation signal S′ following the quantization.

Most conventionally used voice coders do not solve this problem at all.

Many voice coders, such as, for example, the GSM Enhanced Full Rate (GSM-EFR) coder, perform a scalar quantization of the amplification factors. In this case this means that the adaptive amplification factor with 4 bits per subframe and the fixed amplification factor with 5 bits per subframe can be quantized individually and independently of each other. This has the advantage that with certain non-stationary voice sections, the onsets for example, the adaptive amplification factor can easily be quantized to zero, and the fixed amplification factor can assume a value independent of this following quantization.

Compared with the vector quantization, however, it has the disadvantage of lower coding efficiency: In the GSM-EFR coder, 4+5=9 bits are required for the amplification factors, whereas 7 bits are sufficient for a vector quantization.

A further disadvantage here is also that no additional bits are available in order to quantize the fixed excitation or the fixed amplification factor with correspondingly greater precision. The bits of the adaptive codebook, in other words the voice base frequency, remain unused in the case where the adaptive amplification factor was chosen as zero.

In contrast, the GSM Half Rate (GSM-HR) coder operates in a number of modes. It is provided in one mode that in certain subframes, those representing onsets for example, the adaptive codebook is replaced by a second fixed codebook. This solves the problem to a certain extent, but requires a relatively high complexity and also memory space to store the second codebook. There is also an increase in susceptibility to bit errors during transmission, since a totally new codec parameter is used depending on the mode.

In addition, with the GSM-HR codec the deactivation of the adaptive codebook must be explicitly signaled by means of mode bits.

The object of the present invention is therefore to specify a method for encoding and transmission which operates economically in terms of memory space, efficiently and with minimal proneness to error, executes especially efficiently in respect of complexity and coding, and at the same time has a high signal quality following decoding.

This object is achieved by the independent claims 1 and 6.

Developments are derived from the independent claims.

According to the invention the value of the first amplification factor, which is assigned to an adaptive codebook, is specified for specific values of a signal classifier. By this means it is possible to achieve a reduction in the amount of data required to represent the first amplification factor and adaptive codebook entry in their entirety. The voice signal is divided up into individual time sections. These sections can represent, for example, frames or subframes.

The signal classifier indicates, for example, whether a stationary or a non-stationary voice section is present, in other words whether the voice section is, say, a voice onset. If a case of this type is now present, a value specified by means of the signal classifier can be assigned to the first amplification factor. This value of the first amplification factors can be specified, by suitable indexing for example, in such a way that this representation of the value requires fewer bits than a conventional representation. Equally, it is of course alternatively, optionally or additionally possible to achieve a compression in that, if the first amplification factor is specified, the representation of the entry in the adaptive codebook is compressed. Thus, compared with the prior art, this results in a coding-efficient representation of at least one parameter which occurs in the course of voice encoding.

This method proves to be advantageous in particular if the first amplification factor is fixed at zero. By this means the quality of the voice-decoded signal is increased, since, as described at the beginning, fewer quantization error signal components, for example, occur in the case of non-stationary voice sections.

Another development provides that the second amplification factor is scalar quantized if the first amplification factor is specified. For example, the resolution of the quantization of the second amplification factor can then be increased.

Thus, for example in the case of voice onsets which are represented by the fixed component of the excitation g_{—}2*S_f, an expanded range of values can be allowed for the second amplification factor, thereby enabling a more precise description of a voice signal section of this kind.

In another development it is provided that the coder operates at a fixed data rate; in other words, a fixed amount of data is provided for a section of a voice signal. The achieved reduction in the amount of data used to represent the first amplification factor and alternatively or optionally the adaptive codebook entry can be utilized so that the portion of the data set now not filled with data is used to represent other parameters which occur during the voice encoding.

In another development it is provided that the voice section is represented using a reduced amount of data. This method can be used in particular during the use of an encoding method operating at a variable bit rate.

The invention further relates to a method for transmitting voice signals which are coded according to one of the preceding claims.

It is important here that the first amplification factor and/or the adaptive codebook entry are not transmitted.

This method has advantages in particular if it is indicated by means of information sent to the receiver, the decoder for example, that this reduction in the amount of data used to represent individual parameters has been performed. This information can for example occupy a portion of the data set not filled with data as a result of the reduction or also be sent in addition to the data set of the frame or subframes.

The invention is described below with reference to several exemplary embodiments which are explained in part by means of figures, in which:

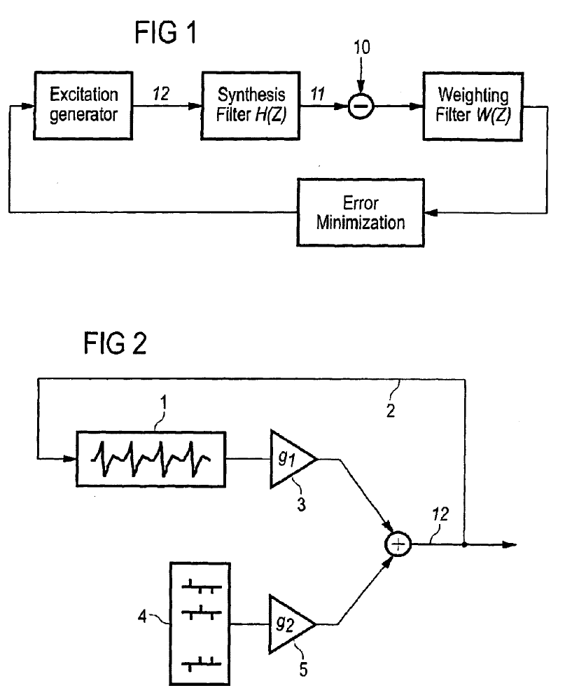

FIG. 1 shows a schematic overview of the analysis-by-synthesis principle in voice encoding

FIG. 2 shows the use of adaptive and fixed codebook with the associated amplification factors.

FIG. 1 shows the schematic sequence of a voice encoding process according to the analysis-by-synthesis principle.

Essentially, the original voice signal 10 is compared with a synthesized voice signal 11. The synthesized voice signal 11 should be such that the divergence between the synthesized voice signal 11 and the original voice signal 10 is minimal. This divergence may also be spectrally weighted. This is effected by way of a weighting filter W(z). The synthesized voice signal is produced with the aid of an LPC synthesis filter H(z). This synthesis filter is excited via an excitation signal 12. The parameters of this excitation signal 12 (and if necessary also the coefficients of the LPC synthesis filter) are finally transmitted and should therefore be coded as efficiently as possible.

The invention therefore aims to provide the most efficient representation possible of the parameters which describe the excitation generator.

The excitation generator without following LPC synthesis filter can be seen in detail in FIG. 2.

The excitation signal 12 is made up of an adaptive component, by means of which the predominantly periodic voice sections are represented, and a fixed component, which is used to represent non-periodic sections. This has already been described in detail in the introductory remarks. The adaptive component is represented using the adaptive codebook 1, the entries in which are weighted with a first amplification factor 3.

The entries in the adaptive codebook 1 are specified by means of the preceding voice sections. This is effected via a feedback loop 2. The first amplification factor 3 is determined by the adaptation to the original voice signal 10. As the name implies, the fixed codebook 4 contains entries which are not determined by a preceding time section. Each codebook entry, referred to as the code word, an algebraic code vector, is a pulse sequence which has values not equal to 0 only at a few defined moments in time. That entry or excitation sequence is selected by means of which the divergence of the synthesized signal 11 from the original voice signal 10 is minimized. The amplification factor 5 assigned to the fixed codebook is specified accordingly.

First it is provided that what is termed a signal classifier is calculated for each frame. This signal classifier can, for example, provide a binary decision as to whether the adaptive codebook is to be used or not. An onset detector may be used for this purpose. It is provided that as a function of the classifier the adaptive amplification factor is set to zero; that is, the adaptive excitation is not included in the overall excitation signal of the LPC synthesis filter. It is further provided that at least one parameter is no longer transmitted. For this there are a number of useful alternatives:

If, for example, the value 0 is transmitted for the adaptive amplification factor, the adaptive codebook entry (in other words the voice base frequency) no longer needs to be transmitted, since it would in fact be multiplied by a zero on the receive side in any case.

If, for example, the setting to zero of the adaptive excitation is signaled to the decoder by means of a reserved word of the adaptive codebook (in other words the voice base frequency), the adaptive amplification factor no longer needs to be transmitted. In the case of a vector quantization of adaptive and fixed amplification factor, the fixed amplification factor could, for example, be scalar quantized.

If the classifier is transmitted by means of an explicit bit, then in the case of an onset even the transmission of adaptive codebook entry (voice base frequency) and adaptive amplification factor can be dispensed with.

An advantage of each of these possible implementations is that a smaller number of bits can be transmitted compared with the state of the art. With coding methods operating at a fixed bit rate, these bits can now be used to improve the quantization of the fixed amplification factor and/or the quantization of the fixed excitation and/or the quantization of the LPC coefficients. In general, each remaining codec parameter can potentially benefit from an improved quantization. In contrast to the GSM-HR coder, no new parameter is provided (in other words no second fixed codebook), but instead the improved quantization of already existing parameters. This saves on computing complexity and memory space requirements and enables specific characteristic features of subframes with onsets to be taken into account. Moreover, memory space efficient coding can be realized by skillful integration of the additionally usable bits into the quantization tables of other codec parameters.

To sum up, it can be said that by setting the adaptive excitation to zero in the case of an onset, and by using freed-up bits of the adaptive excitation or the adaptive amplification factor, an improvement in the quantization of remaining codec parameters can be achieved.

A skillful integration of the additionally freed-up bits will be briefly outlined below. Assuming the setting to zero of the adaptive excitation is signaled by means of a reserved word in the adaptive codebook, then the fixed amplification factor which was previously vector quantized together with the adaptive amplification factor using 7 bits can, for example, be scalar quantized with roughly the same quantization error using 5 bits.

The values of the fixed amplification factor quantized using 5 bits could result from a 25% subset of the 7-bit vector codebook, and in fact a subset addressable by means of any 5 bits out of the 7 bits. An implementation of the 5-bit scalar quantizer of this type saves on additional memory space. The 2 bits that become free can now be used, for example, for more accurate quantization of the fixed excitation.

In addition to the examples presented here, the scope of the invention includes a plurality of further embodiments which can be translated into practice without great effort by a person skilled in the art on the basis of the explanations given.

1. Method for encoding voice signals,
wherein the voice signal is divided up into voice signal sections,
wherein the excitation signal for the synthesis filter can be put together at least by means of a fixed codebook and an assigned second amplification factor, and optionally by means of an adaptive codebook with an associated first amplification factor,
wherein the voice signal section is classified in terms of specific speech characteristics by means of a signal classifier, and
wherein the value of the first amplification factor is specified as a function of the signal classifier, as a result of which the amount of data required to represent the adaptive codebook entry and first amplification factor in their entirety is reduced.

2. Method according to claim 1, wherein the first amplification factor is fixed at zero.

3. Method according to one of the claims 1 or 2, wherein the second amplification factor is scalar quantized.

4. Method according to one of the preceding claims, wherein a previously specified amount of data is reserved for a voice signal section and on account of the reduction in the amount of data used to represent the first amplification factor and the entry of the adaptive codebook in their entirety, at least one other parameter which occurs in the course of the voice encoding takes up a greater portion of the previously specified amount of data.

5. Method according to claim 1, wherein a smaller number of bits is required for representing the voice signal section owing to the fixed specification of the first amplification factor.

6. Method for transmitting voice signals coded according to one of the claims 1 to 5, wherein the adaptive codebook entry and/or the first amplification factor is not transmitted.

7. Method according to claim 6, wherein it is indicated to a receiver by means of information reserved for this purpose that the first amplification factor is set to a value known to the receiver.
